(19) United States
(12) Patent Application Publication
(10) Pub. No.: US 2021/0095808 A1
(43) Pub. Date: Apr. 1, 2021

(54) Flushing Lid Accessories

(71) Applicant: Paul Spiller, Elgin, IL (US)

(72) Inventor: Paul Spiller, Elgin, IL (US)

(21) Appl. No.: 17/035,489

(22) Filed: Sep. 28, 2020

Related U.S. Application Data
(60) Provisional application No. 62/906,970, filed on Sep. 27, 2019.

(51) Int. Cl. F16L 55/11

(52) U.S. Cl. CPC F16L 55/1108

(57) ABSTRACT

Improved attachments for repair of a backflow assembly apparatus are contemplated herein. The attachments attaching to the backflow assembly at an inlet, a first valve control assembly connecting the inlet to the body, an outlet, and a second valve control assembly connecting the outlet to the body.

### PRIORITY

This application claims the benefit of application 62/906,970 filed Sep. 28, 2020.

### FIELD OF THE INVENTION

The present disclosure generally relates to flushing and backflow assemblies and improved attachments. The assembly is installed to prevent backflow and backpressure of contaminated materials into the potable water supply, and allows the draining thereof.

### BACKGROUND

Plumbing is an important aspect of modern life. However, in many instances things go awry in public, commercial, and private home plumbing resulting in temporary reductions in water pressure. This can result in water contamination and illness. Thus there is a significant need for assemblies that reduce the risk to the water supply.

Modern water distribution systems are designed to keep the water flowing to alleviate these risks. However, as a result of deviations from the norm, under certain hydraulic conditions within a water distribution system “normal” flow patterns no longer occur, as a result water flow to the customer can be reversed. When this undesirable reversal of flow happens, contaminated water can enter the distribution system through a cross-connection (a connection between potable water plumbing to a non-potable pipe system). Cross connections are common in swimming pools, sprinkler systems, and fountains. Thus, in such systems it is important to reduce the causes of backflow and to ameliorate the troubles caused by backflow.

Another situation that can cause a risk to a water distribution system is back-siphonage. Back-siphonage is a sudden reduction in the water pressure in the water distribution system, such as during firefighting activities, or when a water main breaks, vigorous water main flushing events, electric power interruption, or distribution system equipment failure. These events may drastically lower distribution system pressure and create a suction effect in the main distribution lines. This can draw a non-potable substance or water that has been contaminated by contact with the environment into the potable water system through a cross connection.

Finally, backpressure is another risk to modern water distribution systems, created when pressure in a non-potable system (as in a re-circulating system containing soap, acid, or antifreeze) exceeds that in the pressure in a connected potable system that provides makeup water to the system. This can force the potable water to reverse its direction of flow through a cross connection. Non-potable substances can then enter the potable water system, contaminating the systems.

As a result of the risk of backflow, many devices exist to prevent it from contaminating the potable water supply. These are generally known as backflow prevention assemblies and include: Air Gap (AG); Double Check Valve Assembly (DC); Reduced Pressure Principal Assembly (RP); Pressure Vacuum Breaker Assembly (PVB); reduced pressure zone (RPZ) and Spill Resistant Pressure Vacuum Breaker (SVB), although there are other types of these devices and people can adapt the attachments herein to many of those devices as well. One difficulty in such systems is that they require a relief valve for expelling contaminated or potentially contaminated water, as well as for pressure relief. Many such systems today have extremely low flow and thus are not capable of reducing pressure quickly and conveniently. The need for innovative solutions to backflow is shown below.

U.S. Pat. No. 3,996,962, issued to Sutherland, describes a backflow prevention assembly designed for connection between a main supply line and a service pipe in water supply service, comprising two check valves in series and a relief valve for draining the chamber between the two check valves under certain operating conditions.

U.S. Pat. No. 4,893,654, issued to Feuz describes a backflow preventer assembly for a liquid supply line includes a single unitary valve body including flanged inlet and outlet end openings and a single access opening generally normal to the flow path defined by the inlet and outlet openings. The body houses a pair of check valve seats on opposite sides of the access opening for seating a pair of check valves mounted in series to permit flow from the inlet opening to the outlet openings. Adjustable compression rods interconnecting the two check valves seat the valves against their oppositely facing valve seats. The check valves and compression rods are sized to enable installation and removal of the valves through the access opening. In one embodiment the valve body has a predetermined length for installation in the liquid supply line between a pair of gate valve assemblies, such length being the same as a standard body length for a single check valve assembly. In a second embodiment, the single unitary body incorporates, in addition to check valve assemblies, a pair of gate valve housings one on each of the opposite sides of the gate valve assemblies so that the single valve body can incorporate, as a unit, the complete backflow preventer assembly including gate valves and double check valves.

U.S. Pat. No. 6,021,805, issued to Horne et. al, describes a backflow preventer assembly includes a housing, a first mounting assembly configured for assembling by insertion with a first end of the housing, and a second mounting assembly configured for assembling by insertion with a second end of the housing. The housing and mounting assemblies include through bores in fluid communication. Securing material secures opposed surfaces of the first mounting assembly and the housing, and opposed surfaces of the second mounting assembly and the housing. Plating material is located on the inner surfaces of the housing and mounting assemblies. The plating material forms a wall restricting migration of the securing material into the housing and mounting assembly bores. Ball valves and check valves are attached to the mounting assemblies. The housing wall defines a port providing access to the check valves.

Chinese Patent No. CN202056265 to Wensheng Li et al discloses an internal circulation type backflow assembly for a ball screw, which is assembled in a pre-arranged accommodating hole arranged on the periphery of a screw cap from inside to outside. The backflow assembly is provided with a backflow channel, the two ends of the backflow channel are respectively provided with an arc-shaped curved channel, and the two sides of the backflow channel are respectively provided with an extension arm. A half length of the center line of the arc-shaped curved channels arranged at the two ends of the backflow channel and the arc edge radius of the inner side of the arc-shaped curved channels are 0.9 time to 1.1 times of the diameter of a ball. The center line of the two extension arms aligns with the central point of the arc-shaped curved channels, accordingly the backflow of the ball is smoother, the ball blockage is avoided, and the bump is greatly reduced.

These problems, and others, have been addressed by the improved backflow assemblies and flushing lid attachments disclosed herein and discussed in greater detail below.

### BRIEF SUMMARY

Thus, to solve such problems and others, new improvements and attachments are discussed for use while repairing or servicing backflow assemblies. These novel attachments will allow for easier repairs of backflow assemblies and can be used individually or in conjunction with many models of backflow assemblies.

These improved attachments can expedite and speed repair or clearing out of debris that have accumulated in the assemblies. For example, a technician may remove the relief valve on the bottom of a backflow assembly they are going to flush and install one of the attachments presented herein. If the relief valve was left in place, it would spray water all over the place without the attachments. Thus, they are used to plug or cap the relief valve to prevent unwanted water or debris from spraying all over while flushing the a backflow assembly.

The advantages of such an application become clear when one is experienced with backflow assemblies and the difficulties of servicing them. Typical devices currently on the market do not have the confluence and plethora of features contemplated and described herein.

In a first embodiment the disclosure contemplates a improved plug for a backflow assembly, the plug having, a top nut attached to a bottom cylinder, the cylinder being capped on the end that is attached to the top nut, the cylinder having an internal cavity that has a cross section that is a rounded rectangle, the cylinder having external threading on at least a portion of its external surface, and the top nut having a diameter that is smaller than the cylinder. The plug also may preferably have the external threading is located on the bottom portion of the cylinder; the threading covers at least one half of the external surface of the cylinder; the top nut has an internal surface that is cylindrical in shape; the internal surface of the top nut is threaded; the top nut is a hexagonal nut; a backflow prevention assembly, the plug connected to the backflow prevention assembly at a relief valve.

In another embodiment the disclosure contemplates an improved plug for a backflow assembly, the plug having a top nut attached to a center cylinder, the center cylinder being capped on the end that is attached to the top nut, and the center cylinder being attached to a bottom cylinder the bottom cylinder having an opening opposite the center cylinder and having a diameter lager than the center cylinder, the center and bottom cylinders forming an internal cavity that has a cross section that appears like a stepped pyramid, the bottom cylinder having internal threading on at least a portion of its internal surface, and the top nut having a diameter that is smaller than the center cylinder. The plug may also preferably have the threading covers at least one half of the external surface of the cylinder, the top nut has an internal surface that is cylindrical in shape, the internal surface of the top nut is threaded; the top nut is a hexagonal nut; a backflow prevention assembly, the plug connected to the backflow prevention assembly at a relief valve.

In another embodiment the disclosure contemplates sn improved nipple for a backflow assembly, the nipple having a cylinder portion and a bottom threaded portion, the threaded portion having a larger external diameter than the cylinder portion, the cylinder portion being substantially hollow and having a first internal diameter and a second internal diameter the first diameter being the portion opposite the threaded portion and having a larger diameter than the second diameter. The nipple also may preferably have the threading covers at least one half of the internal surface of the threaded portion, the threading is 2.75×6.0 thread; the cylinder portion is partially threaded, the threading covering the internal surface covering the first internal diameter; a backflow prevention assembly, the nipple connected to the backflow prevention assembly at a relief valve.

Such embodiments do not represent the full scope of the invention. Reference is made therefore to the claims herein for interpreting the full scope of the invention. Other objects of the present invention, as well as particular features, elements, and advantages thereof, will be elucidated or become apparent from, the following description and the accompanying drawing figures.

### DESCRIPTION OF THE DRAWINGS

The present invention may be better understood, and its numerous objects, features, and advantages made apparent to those skilled in the art by referencing the accompanying drawings.

FIG. 1 is a is a side view of a backflow assembly according to the present disclosure.

FIG. 2 is a perspective view of an improved plug according to the present disclosure.

FIG. 3 is a cross sectional view of the improved plug of FIG. 2.

FIG. 4 is a perspective view of an improved plug according to the present disclosure.

FIG. 5 is a cross sectional view of the improved plug of FIG. 4.

FIG. 6 is a perspective view of an improved nipple according to the present disclosure.

FIG. 7 is a cross sectional view of the improved plug of FIG. 6.

### DETAILED DESCRIPTION

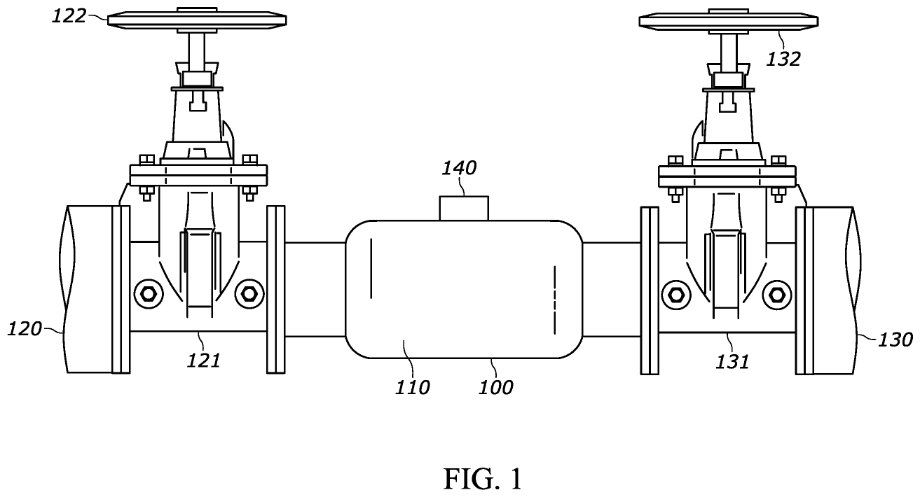

Referring now the drawings with more specificity, the present disclosure essentially provides improved attachments for a backflow assembly. The preferred embodiments of the improvements will now be described with reference to FIGS. 1-7 of the drawings. Variations and embodiments contained herein will become apparent in light of the following descriptions.

FIG. 1 shows an exemplary backflow assembly apparatus 100 including improved access lid 10. In this improved assembly, access point 140 is attached to the main body 110 of the backflow assembly 100. The access point 140 is threaded and can take various attachments including relief valves and flushing hoses, which allow for a controlled flushing of the assembly 100 at high flow and pressure. As assembly 100 is an exemplary backflow assembly, other orientations may be considered for use with attachments contemplated herein. In this orientation, water typically flows through inlet 120 and through the first valve assembly 121 which is selectively controlled by valve control 122 (to adjust pressure and flow). Water then passes into the body 110 and then, in typical operation into the 2nd valve assembly 131 (controlled by control 132), and passes through the outlet 130. However, after certain conditions (discussed above and below) the assembly 100 can become contaminated with debris. In such situations, a valve can be opened to flush water out of the body 110 via a hose or other implement.

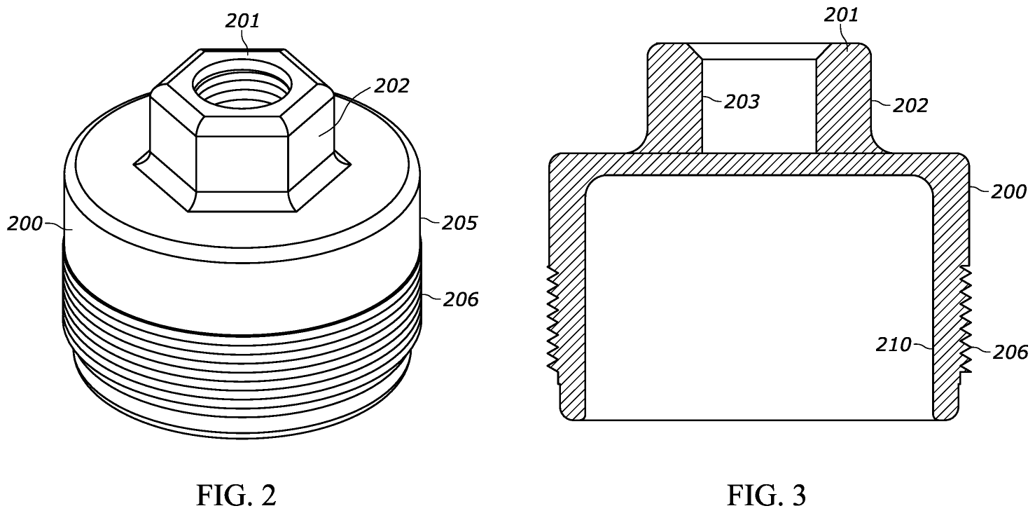

Looking now to FIGS. 2 & 3 an improved plug 200 is shown. Plug 200 is formed by a top nut 201 with external sidewall 202 and internal surface 203. The external sidewall 202 may preferably be hexagonal and the internal surface 203 may be threaded. The top nut 201 is mounted o a bottom cylinder 205 which is at least partially threaded 206 and has a hollow interior 210. Interior's 210 cross section is approximately a rounded rectangle shape. This can be used for plugging a backflow assembly such as backflow assembly 100 by attaching to a relief valve on the backflow assembly.

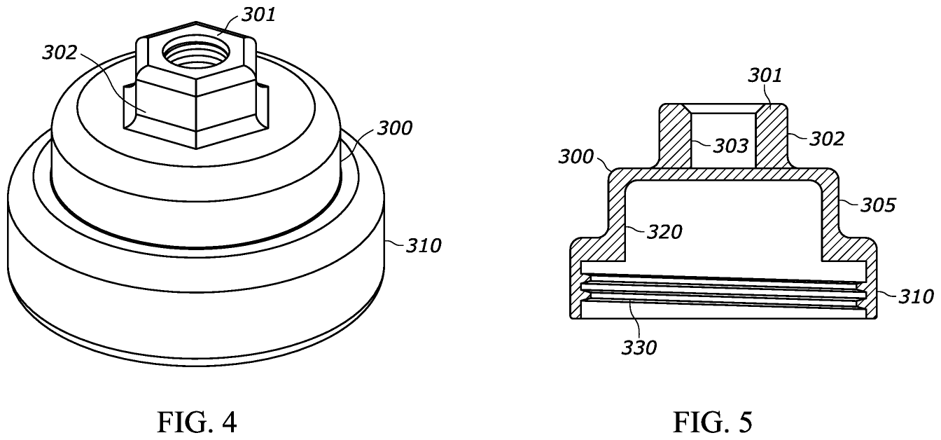

Looking now to FIGS. 4 & 5 an improved plug 300 is shown. Plug 300 is formed by a top nut 301, middle cylinder 305, and bottom cylinder 310. Top nut 301 is formed with an external sidewall 302 and internal surface 303. The external sidewall 302 may preferably be hexagonal and the internal surface 303 may be threaded. Bottom cylinder 310 is larger than the top cylinder 305 and may preferably be threaded 330. The internal walls of cylinders 305, 310 form and internal surface 320 which has a cross section generally shaped like two stacked rectangles that differ in size. This can be used for plugging a backflow assembly such as backflow assembly 100 by attaching to a relief valve on the backflow assembly.

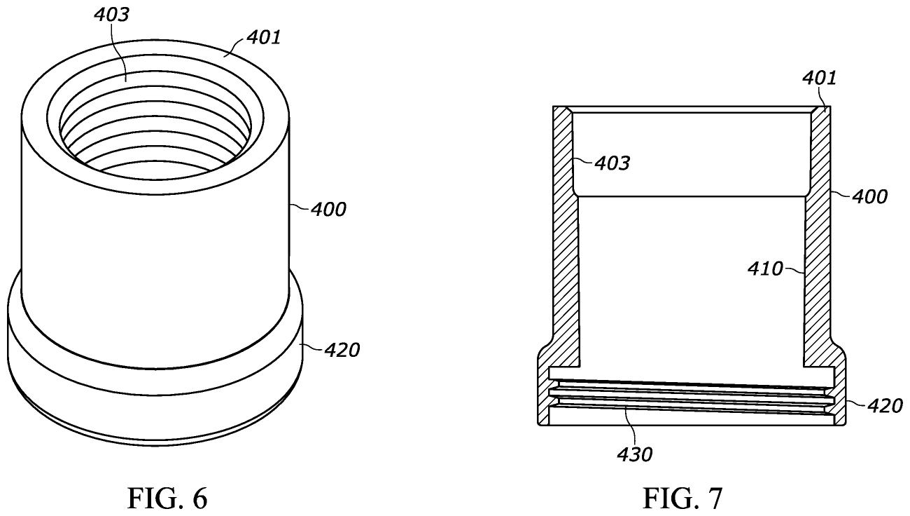

Looking to FIGS. 6 & 7 an improved nipple 400 is shown. The nipple 400 is generally cylindrical in shape and has a top 401 and internal threading 403 near top 401. The bottom portion 420 of nipple 400 is generally wider, and may be threaded 430. Internal section 410 forms a path that can allow the passage of water and debris. Thread 430 are set so they may screw into a backflow prevention assembly. The nipple, thereby may be threaded at the top 403 and bottom 430, but these threads may preferably be different in width.

### INDUSTRIAL APPLICABILITY

An exemplary backflow reduced pressure assembly that may be used with the attachments is the Series 4000SS reduced pressure zone assemblies. This assembly and those similar, are designed to provide protection of the potable water supply in accordance with national codes. This series can be used where approved by the local authority having jurisdiction on health-hazard cross-connections. The attachments described herein are matable with such devices for aiding repair and high-flow flushing of the assembly after a failure of the water supply system that may have resulted in contamination.

Plug 200 is a novel capping plug that stops flow and can be constructed of steel or other plumbing materials used in the art. Top nut 201 may preferably be 1.25″ in diameter and internal surface 203 being ¾″. Bottom cylinder 205 may preferably be 2.25″ in diameter and hollow interior 210 can be 1.944″ to 2.235″ in diameter. Total height of plug 200 may preferably be 2.125″.

Plug 300 is a novel capping plug with nonstandard threading 330. Top nut 301 may preferably be 1.25″ in diameter and internal surface 303 being ¾″. Bottom cylinder 310 may preferably be 3.00″ in diameter and hollow interior 320 can be 1.95″ in diameter. Total height of plug 300 may preferably be 2.100″.

Nipple 400 is a nonstandard nipple that may preferably use nonstandard 2.75×6 ACME thread. Near top 401 nipple 400's diameter may preferably be 2.70″ while inner diameter 403 may be 2.424″. At bottom 420 nipple 400's diameter may preferably be 3.0″. Total height of nipple 400 may preferably be 3.125″.

Accordingly, although the invention has been described by reference to certain preferred and alternative embodiments, it is not intended that the novel arrangements be limited thereby, but that modifications thereof are intended to be included as falling within the broad scope and spirit of the foregoing disclosures and the appended drawings.

I claim:

1. An improved plug for a backflow assembly, the plug comprising:
a top nut attached to a bottom cylinder, the cylinder being capped on the end that is attached to the top nut;
the cylinder having an internal cavity that has a cross section that is a rounded rectangle;
the cylinder having external threading on at least a portion of its external surface;
and the top nut having a diameter that is smaller than the cylinder.

2. The plug of claim 1 wherein:
the external threading is located on the bottom portion of the cylinder.

3. The plug of claim 2 wherein:
the threading covers at least one half of the external surface of the cylinder.

4. The plug of claim 1 wherein:
the top nut has an internal surface that is cylindrical in shape.

5. The plug of claim 4 wherein:
the internal surface of the top nut is threaded.

6. The plug of claim 5 wherein:
the top nut is a hexagonal nut.

7. The plug of claim 1 further comprising:
a backflow prevention assembly, the plug connected to the backflow prevention assembly at a relief valve.

8. An improved plug for a backflow assembly, the plug comprising:
a top nut attached to a center cylinder, the center cylinder being capped on the end that is attached to the top nut, and the center cylinder being attached to a bottom cylinder the bottom cylinder having an opening opposite the center cylinder and having a diameter lager than the center cylinder;
the center and bottom cylinders forming an internal cavity that has a cross section that appears like a stepped pyramid;
the bottom cylinder having internal threading on at least a portion of its internal surface;
and the top nut having a diameter that is smaller than the center cylinder.

9. The plug of claim 8 wherein:
the threading covers at least one half of the external surface of the cylinder.

10. The plug of claim 9 wherein:
the top nut has an internal surface that is cylindrical in shape.

11. The plug of claim 10 wherein:
the internal surface of the top nut is threaded.

12. The plug of claim 11 wherein:
the top nut is a hexagonal nut.

13. The plug of claim 8 further comprising:
a backflow prevention assembly, the plug connected to the backflow prevention assembly at a relief valve.

14. An improved nipple for a backflow assembly, the nipple comprising:
a cylinder portion and a bottom threaded portion;
the threaded portion having a larger external diameter than the cylinder portion;
the cylinder portion being substantially hollow and having a first internal diameter and a second internal diameter the first diameter being the portion opposite the threaded portion and having a larger diameter than the second diameter.

15. The nipple of claim 14 wherein:
the threading covers at least one half of the internal surface of the threaded portion.

16. The nipple of claim 15 wherein:
the threading is 2.75×6.0 thread.

17. The nipple of claim 15 wherein:
the cylinder portion is partially threaded, the threading covering the internal surface covering the first internal diameter.

18. The nipple of claim 17 further comprising:
a backflow prevention assembly, the nipple connected to the backflow prevention assembly at a relief valve.
